(19) United States
(12) Patent Application Publication
(10) Pub. No.: US 2002/0042288 A1
(43) Pub. Date: Apr. 11, 2002

(54) Multiple-channel portable wireless communication apparatus and method

(76) Inventor: Shuji Nakayama, Tokyo (JP)

Correspondence Address: KNOBLE & YOSHIDA, LLC, Eight Penn Center, Suite 1350, 1628 John F. Kennedy Blvd., Philadelphia, PA, 19103, US

(21) Appl. No.: 09/820,445

(22) Filed: Mar. 29, 2001

(30) Foreign Application Priority Data
Aug. 18, 2000 (JP) 2000-248144

(51) Int. Cl. H04M 1/00

(52) U.S. Cl. 455/553; 455/564; 455/566

(57) ABSTRACT

The multiple calls are made from a single portable wireless communication terminal according to the current invention. The user interface of the preferred embodiments allows the user of the portable wireless communication terminal to easily select a desired channel from a predetermined number of channels to initiate, terminate and accept a call without sacrificing portability.

### FIELD OF THE INVENTION

The current invention is generally related to an apparatus and a method of portable wireless communication, and more particularly related to an apparatus and a method of having multiple-channel communication via a portable wireless device.

### BACKGROUND OF THE INVENTION

In the relevant prior art of wireless portable communication systems, a user initiates a calling procedure in a wireless portable communication device 601 in order to establish a temporary connection with a base station 603 as shown in FIG. 1. The base station 603 is connected to other base stations 604 and 605 via cable network. For example, to connect the wireless portable communication terminals 601 and 602, in response to the calling from the wireless portable communication terminal 601, the base station 603 establishes a channel by calling the wireless portable communication terminal 602 via the base stations 605 and 602. As described above, in the relevant prior art, only a single channel is established between a wireless portable communication device and a base station for transmitting data or voice information.

Referring to FIG. 2, the user interface of the prior art wireless portable communication device 601 is illustrated in a diagram. The user interface includes an off-hook key, a send button or a calling button 701 for initiating a call; an on-hook key, an end button or a terminating button 702 for terminating a call; a set of alpha/numeric keys 703 for inputting information; and a display unit 704 such as a LCD panel for displaying relevant information. To initiate a call, a user inputs a telephone number via the numeric keys 703 and subsequently presses the send key 701 to engage a channel. When a call arrived to the wireless portable communication device 601, the user presses the send key 701 or any other input keys 703 to accept the in-coming call. To end the call, the user presses the on-hook key 702.

The above described prior art wireless portable communication terminal is capable of handling only a single channel at any give time. For this reason, for example, it is impossible for a user to talk to a person via a voice channel while he downloads information data via a data channel through a single prior art wireless portable communication terminal. To accomplish the above described multi-channel call, it is necessary for the user to use two separate prior art wireless portable communication terminals respectively for a voice channel and a data channel. It is desired to have a wireless portable communication device that is capable of handling multi-channels or multiple calls without sacrificing portability or compact size. It is also desired that the multi-channel wireless portable communication device has an easy-to-use user interface.

### SUMMARY OF THE INVENTION

In order to solve the above and other problems, according to a first aspect of the current invention, a method of communicating via a wireless portable device includes: providing a predetermined number of channels in the wireless portable device; providing a predetermined set of actions to be performed using the channels; selecting at least one of the channels; selecting one of the actions to be performed on the selected one of the channels; and performing the selected one of the actions on the selected one of the channels.

According to a second aspect of the current invention, a wireless portable apparatus for communicating through multiple channels, includes: a predetermined number of pairs of a transmitter and a receiver for supporting multiple channels; a control unit connected to the pairs of the transmitter and the receiver for selectively performing a task using at least one of the pairs of the transmitter and the receiver in response to a control signal; and an input device connected to the control unit for inputting the control signal, the control signal being indicative of the task as well as the one of the pairs of the transmitter and the receiver.

These and various other advantages and features of novelty which characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a diagram illustrating a prior art portable wireless communication system.

FIG. 2 is a diagram illustrating a prior art portable wireless communication terminal.

FIG. 3 is a diagram illustrating components of one preferred embodiments of the multi-channel portable wireless communication unit according to the current invention.

FIG. 4 is a flow chart illustrating steps involved in one preferred process of operating the multi-channel wireless communication according to the current invention.

FIG. 5 is a diagram illustrating one preferred embodiment of the multi-channel portable wireless communication system according to the current invention.

FIG. 6 is a diagram illustrating the user interface of a first preferred embodiment of the wireless portable communication device.

FIG. 7A is a diagram illustrating an exemplary user interface in the display unit of the wireless portable communication device in the first preferred embodiment when a single channel is established.

FIG. 7B is a diagram illustrating an exemplary user interface in the display unit of the wireless portable communication device in the first preferred embodiment when two channels are established.

FIG. 7C is a diagram illustrating an exemplary user interface in the display unit of the wireless portable communication device in the first preferred embodiment when a call arrives.

FIG. 7D is a diagram illustrating an exemplary user interface in the display unit of the wireless portable communication device in the first preferred embodiment when a second call arrives while a first call is in progress.

FIG. 8 is a diagram illustrating the user interface of a second preferred embodiment of the wireless portable communication device according to the current invention.

FIG. 9 is a diagram illustrating the exemplary user interface in the display unit 105 of the wireless portable communication device in the second preferred embodiment.

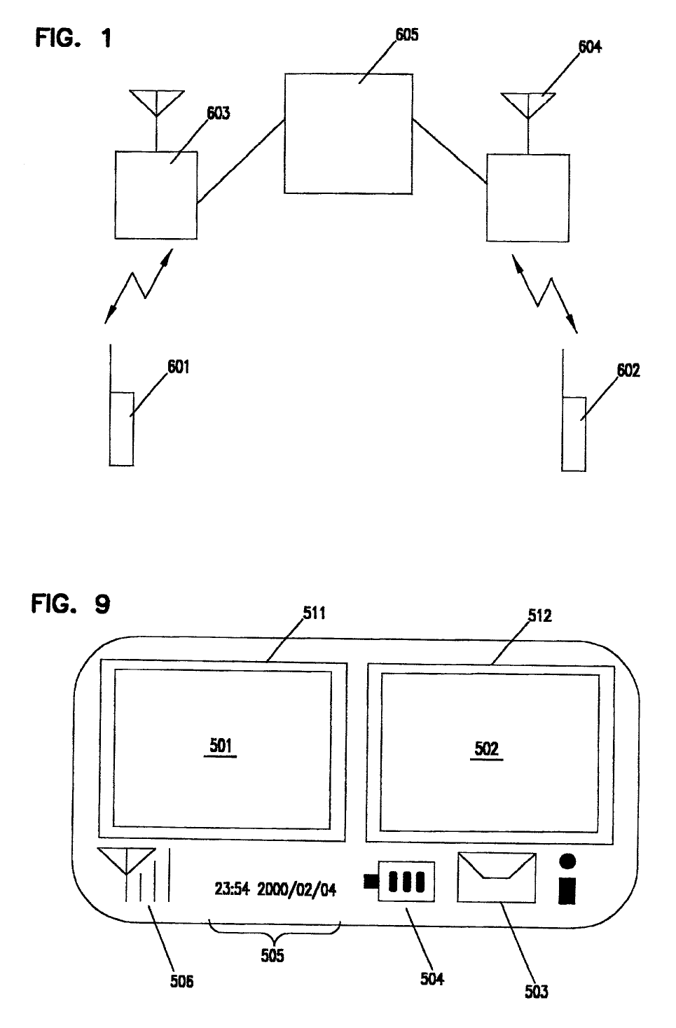

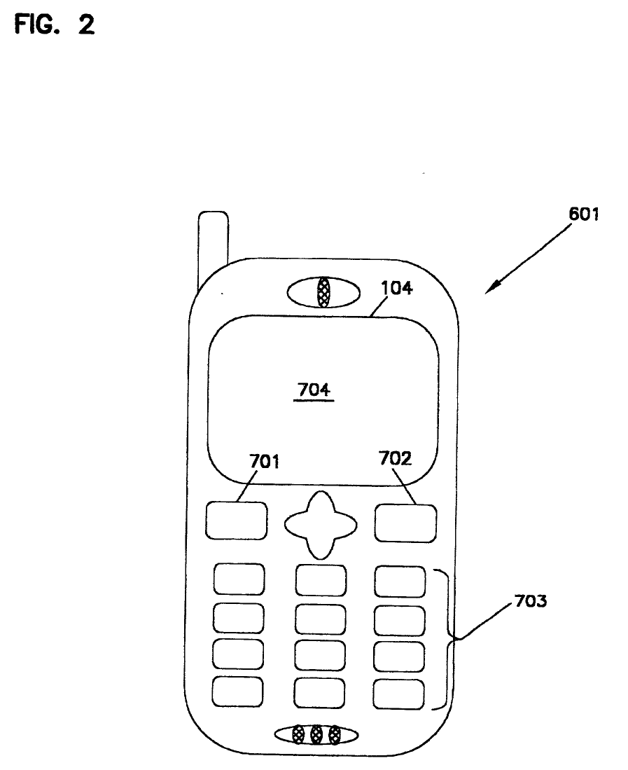

DETAILED DESCRIPTION OF THE PREFERRED EMBODIMENT(S)

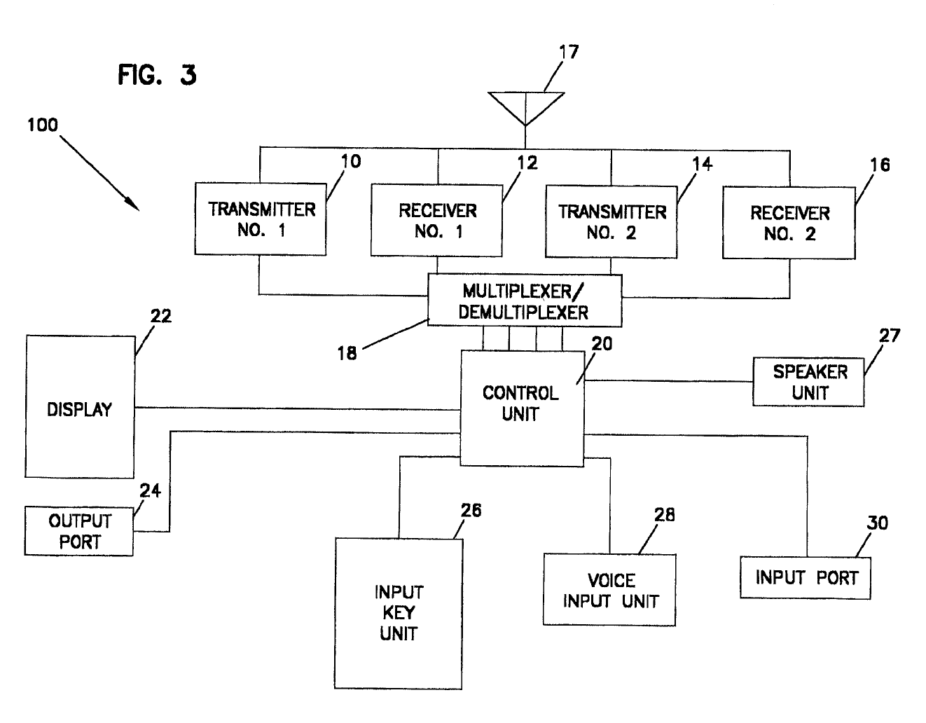

Referring now to the drawings, wherein like reference numerals designate corresponding structures throughout the views, and referring in particular to FIG. 3, a diagram illustrates components of one preferred embodiments of the multi-channel portable wireless communication unit 100 according to the current invention. The multi-channel portable wireless communication unit 100 includes a first pair of a transmitter 10 and a receiver 12, a second pair of a transmitter 14 and a receiver 16, an antenna 17, a multiplexer/demultiplexer unit 18, a control unit 20, a display unit 22, an output port 24, an input key unit 26, a speaker unit 27, a voice input unit 28 and a data input port 30. The first pair of the transmitter 10 and the receiver 12 respectively transmits and receives information on a first channel while the second pair of the transmitter 14 and the receiver 16 respectively transmits and receives information on a second channel. The multiplexer/demultiplexer unit 18 multiplexes and demultiplexes wireless information signals that are to be transmitted and are received via the antenna 17. The control unit 20 is connected to the two pairs of the transmitters 10, 14 and the receivers 12, 16, as well as the above described input/output components. The control unit 20 controls the input signals from the input components such as the input key unit 26, the voice input unit 28 and the data input port 30 before the inputted signals are transmitted via the transmitter 10 or 14. The control unit 20 determines which channel is used for a given transmission. By the same token, the control unit 20 controls the out signals to the output components such as the display unit 22, the voice output unit 27 and the data output port 24 after the outputted signals are received via the receiver 12 or 16.

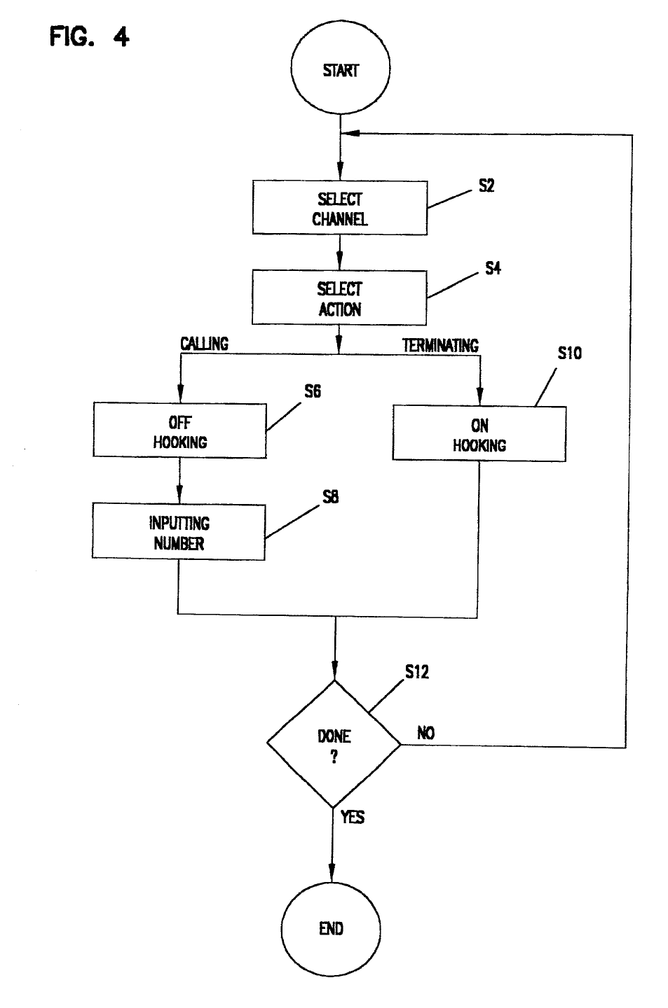

Now referring to FIG. 4, a flow chart illustrates steps involved in one preferred process of operating the multi-channel wireless communication according to the current invention. In general, a channel is selected from a predetermined number of available channels in step S2. According to one example, the channel selection is specified by a dial, a multi-channel selector and any other ways to specify one channel. After a particular channel is selected, one action is selected from a predetermined set of actions in step S4, and the selected action is performed on the selected channel. In this example, the predetermined set of actions includes “initiating” and “terminating” a call. Assuming that the selected channel is not being used, after “calling” is selected in step S4, a number to be called is inputted in step S6 via a key pad and the number is sent or off-hooked in step S8.

Thus, a new call is initiated in the steps S6 and S8. On the other hand, assuming that the selected channel in step S2 is currently being utilized for communication and the selected action in step S4 is “terminating,” the selected channel is on-hooked or disengaged from the current communication in step S10. After the selected action is performed either in step S8 or S10, the preferred process proceeds to step S12 where it is determined whether or not any additional action is to be taken. If no further action is taken, the preferred process ends. On the other hand, if a new action is to be taken, the preferred process goes back to the step S2.

Referring to FIG. 5, a diagram illustrates one preferred embodiment of the multi-channel portable wireless communication system according to the current invention.

The preferred system includes a plurality of portable wireless communication terminals 201, 202 and 203; base stations 204, 205 and 206; a circuit switching station 207; and a data processing unit 208. Any one of the portable wireless communication terminals 201, 202 and 203 is able to handle more than a single channel communication at the same time, and the multi-channel communication includes any combination of voice and data information. For example, the portable wireless communication terminal 201 initiates a channel request to establish a first channel a with the base station 204 to communicate with the portable wireless communication terminal 202 via the circuit switching station 207 and the base station 205. The portable wireless communication terminal 201 further initiates another channel request to establish a second channel b with the base station 204 to communicate with the data processing unit 208 via the circuit switching station 207. Thus, the portable wireless communication terminal 201 is able to communicate with two devices simultaneously through the two separate channels a and b.

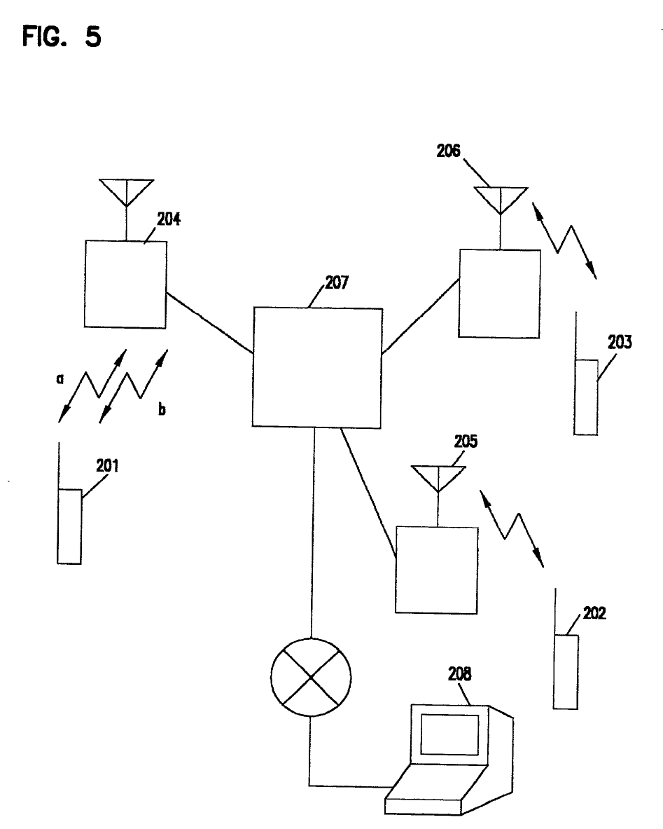

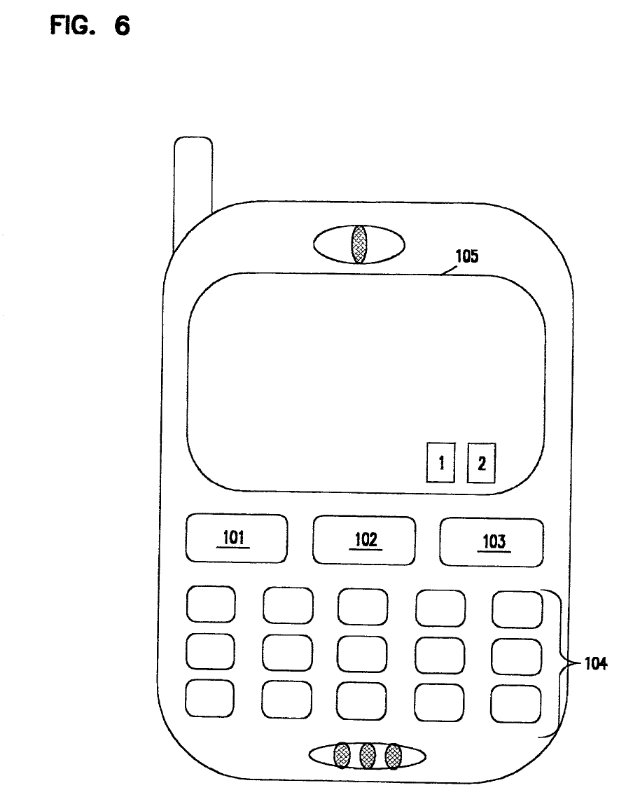

Referring to FIG. 6, the user interface of a first preferred embodiment of the wireless portable communication device is illustrated in a diagram. The user interface includes an off-hook key, a send button or a calling button 101 for initiating a call; an on-hook key, an end button or a terminating button 102 for terminating a call; a multi-call key or channel selector 103 for selecting a channel; a set of alpha/numeric keys 104 for inputting information; and a display unit 105 such as a LCD panel for displaying relevant information. To initiate a call on a first channel, a user first selects a channel by pressing the multi-call key to select the first channel. The selection of a channel is displayed on the LCD panel 105. Then, the user inputs a first telephone number via the numeric keys 104 and subsequently presses the send key 101 to engage the selected first channel. To initiate another call or connection on a second channel, the user selects another available channel by pressing the multi-call key to select the second channel. The selection of a channel is displayed on the LCD panel 105. Then, the user inputs a second telephone number via the numeric keys 104 and subsequently presses the send key 101 to engage the selected second channel.

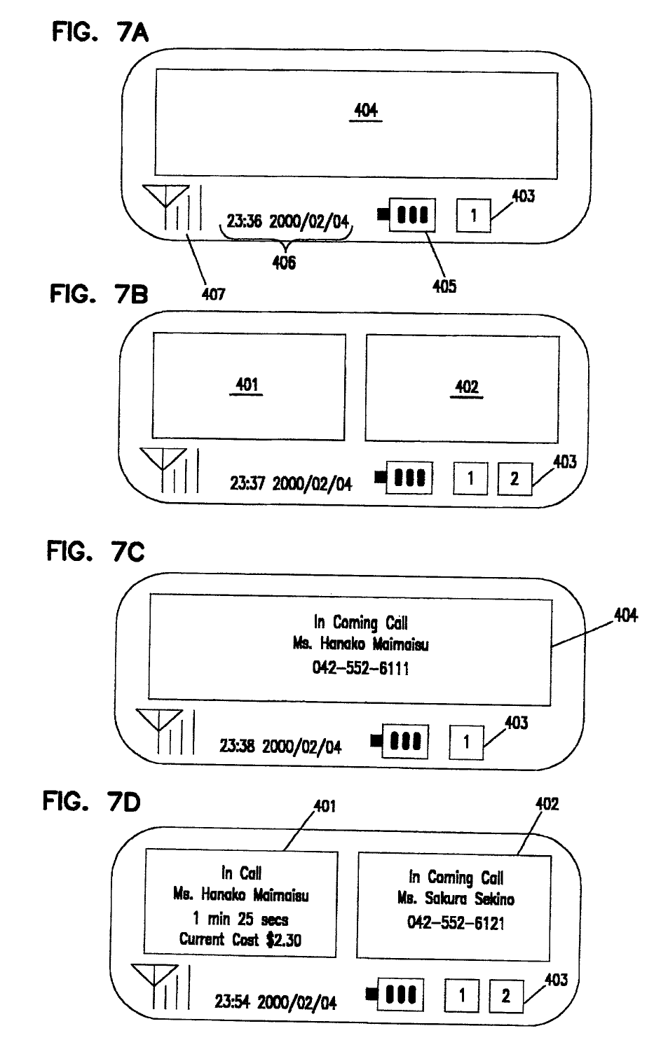

Referring to FIG. 7A, a diagram illustrates an exemplary user interface in the display unit 105 of the wireless portable communication device in the first preferred embodiment when a single channel is established. The display unit 1 OS includes a main display area 404, a channel indicator area 403, a battery indicator area 405, a time/date display area 406 and a signal strength area 407. The display area 404 is initially blank in the display unit 105 in FIG. 7A. The main display area 404 displays information in various forms including alphanumeric characters and video graphics. For data communication, the exemplary displayed information includes retrieved data from a web site, video signals from a video phone, and streamed data from broadcasted streamed data. For voice communication, the exemplary displayed information includes the length of time, the called number and the incurred cost. When only one channel is established, the channel indicator area 403 indicates “1.” All of the display area 404 is used to display information that is related to the single channel communication.

Referring to FIG. 7B, a diagram illustrates an exemplary user interface in the display unit 105 of the wireless portable communication device in the first preferred embodiment when two channels are established. In this example, since the portable wireless communication device is designed to handle up to two channels and one of the two channels is currently being active, under these circumstances the multi-call button selects a second channel. While the first channel is still active, after a second channel is selected and the second number is inputted, the major display area 404 now splits into two equal areas 401 and 402. The first split area 401 displays information relevant to communication via the first channel. The second split area 402 displays information relevant to communication to be established via the second channel while the second channel is being connected. After the second channel is established by off hooking, the channel indicator area 403 now indicates both “1” and “2” to indicate two actively connected channels. The two active channels carry any combination of voice and data information. For example, the two channels are respectively dedicated to voice and data information.

Referring back to FIG. 7A, a diagram illustrates an exemplary user interface in the display unit 105 of the wireless portable communication device in the first preferred embodiment when one of the two channels is deactivated. After selecting a channel from currently active channels by pressing a multi-call button, the selected channel is highlighted in the channel indicator area 403. In this example, since the portable wireless communication device is designed to handle up to two channels and the two channels are currently being active, under these circumstances the multi-call button selects between the two active channels. In an alternative implementation, the multi-call button additionally selects the two active channels at the same time. After a desired channel is selected, the off-hook key deactivates the selected channel. As shown in FIG. 7A, in this example, the channel “2” was deactivated, and the major display area 404 now is now undivided while the channel indicator area 403 indicates only “1” as an active channel.

Referring to FIG. 7C, a diagram illustrates an exemplary user interface in the display unit 105 of the wireless portable communication device in the first preferred embodiment when a call arrives. Assuming that no channel is currently active, when a call arrives, the major display area 404 displays a name of a calling party and the telephone number, and the channel indicator area 403 indicates “1” for the incoming call. To accept the incoming call, either the send button or an input key is pressed, and the channel 1 is activated for communication.

Referring to FIG. 7D, a diagram illustrates an exemplary user interface in the display unit 105 of the wireless portable communication device in the first preferred embodiment when a second call arrives while a first call is in progress. The major display area 404 is now automatically divided. The first display area 401 displays information relevant to the call in progress, and the relevant information includes the name of calling party, the length of the call and the cost of the call. The second display area 402 displays information relevant to the new incoming call, and the information includes a name of the second calling party and the number. If the off-hook key or any input key is pressed, the second incoming call is accepted, and the channel indicator area 403 now indicates the two active channels, “1” and “2.”

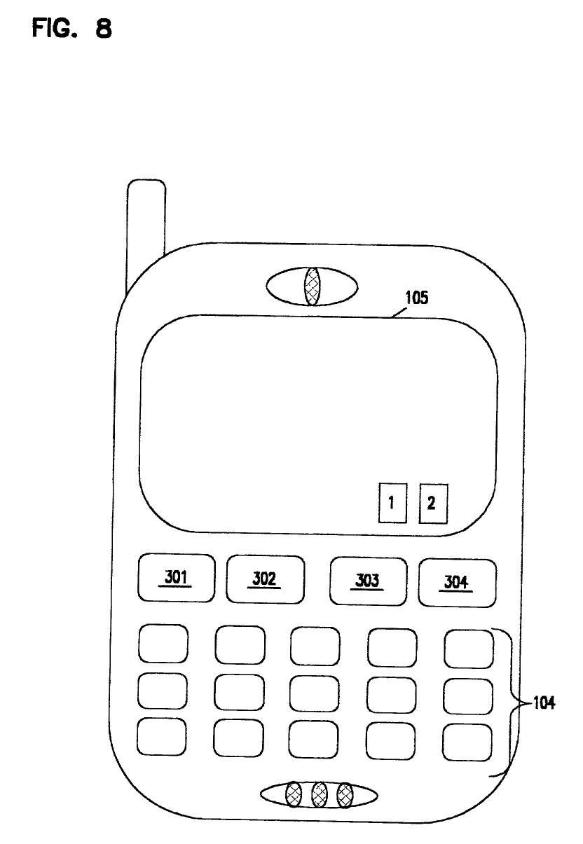

Referring to FIG. 8, the user interface of a second preferred embodiment of the wireless portable communication device is illustrated in a diagram. The user interface includes a first off-hook key, a first send button or a first calling button 301 for initiating a call on a first channel; a first on-hook key, a first end button or a first terminating button 302 for terminating a call on the first channel; a second off-hook key, a second send button or a second calling button 303 for initiating a call on a second channel; a second on-hook key, a second end button or a second terminating button 304 for terminating a call on the second channel; a set of alpha/numeric keys 104 for inputting information; and a display unit 105 such as a LCD panel for displaying relevant information. In the second embodiment, a pair of the send button and the end button is dedicated to each channel. To initiate a call on a first channel, a user first inputs a telephone number and presses either of the first send button 301 or the second send button 303. To initiate another call or connection on a second channel, the user inputs a second telephone number and presses the send button that corresponds to an available one of the two channels. The currently active channels are displayed on the LCD panel 105. Similarly, to deactivate the channels, a corresponding one of the two end buttons 302, 304 is pressed.

Referring to FIG. 9, a diagram illustrates the exemplary user interface in the display unit 105 of the wireless portable communication device in the second preferred embodiment. In this example, since the portable wireless communication device is designed to handle up to two channels, two separate display areas 501 and 502 are always divided. The first split area 501 displays information relevant to communication via the first channel. The second split area 502 displays information relevant to communication via the second channel. The active channel indicators 511 and 512 highlight a corresponding active channel. The highlighting is alternatively using a different color rather than on or off. The user interface additionally includes a message indicator area 503, a battery indicator area 504, a data/time area 505 and a signal strength area 506. The two active channels carry any combination of voice and data information. For example, the two channels are respectively dedicated to voice and data information.

It is to be understood, however, that even though numerous characteristics and advantages of the present invention have been set forth in the foregoing description, together with details of the structure and function of the invention, the disclosure is illustrative only, and that although changes may be made in detail, especially in matters of shape, size and arrangement of parts, as well as implementation in software, hardware, or a combination of both, the changes are within the principles of the invention to the full extent indicated by the broad general meaning of the terms in which the appended claims are expressed.

What is claimed is:

1. A method of communicating via a wireless portable device, comprising:
providing a predetermined number of channels in the wireless portable device;
providing a predetermined set of actions to be performed using the channels;
selecting at least one of the channels;
selecting one of the actions to be performed on the selected one of the channels; and
performing the selected one of the actions on the selected one of the channels.

2. The method of communicating via a wireless portable device according to claim 1 wherein the predetermined number of the channels includes any combination of a voice channel and a data channel.

3. The method of communicating via a wireless portable device according to claim 1 wherein the predetermined set of the actions includes on-hooking and off-hooking.

4. The method of communicating via a wireless portable device according to claim 1 further comprising:
communicating information through a plurality of the channels; and
displaying the information in a predetermined manner for each of the channels.

5. The method of communicating via a wireless portable device according to claim 1 wherein the information includes availability of each of the channels.

6. The method of communicating via a wireless portable device according to claim 1 wherein said selecting the one of the channels is accomplished by pressing an off-hook key that corresponds to the selected one of the channels.

7. The method of communicating via a wireless portable device according to claim 1 wherein said selecting the one of the channels is accomplished by pressing a channel selection key for selecting the selected one of the channels.

8. A wireless portable apparatus for communicating through multiple channels, comprising:
a predetermined number of pairs of a transmitter and a receiver for supporting multiple channels;
a control unit connected to said pairs of said transmitter and said receiver for selectively performing a task using at least one of said pairs of said transmitter and said receiver in response to a control signal; and
an input device connected to said control unit for inputting the control signal, the control signal being indicative of the task as well as the one of said pairs of said transmitter and said receiver.

9. The wireless portable apparatus for communicating through multiple channels according to claim 8 wherein said transmitter and said receiver communicate any combination of voice information and data information.

10. The wireless portable apparatus for communicating through multiple channels according to claim 8 wherein the task includes on-hooking and off-hooking.

11. The wireless portable apparatus for communicating through multiple channels according to claim 9 further comprising:
a display unit connected to said control unit for displaying the data information in a predetermined manner for each of the multiple channels; and
a speaker unit connected to said control unit for outputting the voice information.

12. The wireless portable apparatus for communicating through multiple channels according to claim 11 further comprising:
an input port connected to said control unit for inputting the data information;
a voice input unit connected to said control unit for inputting the voice information; and
an output port connected to said control unit for outputting the data information.

13. The wireless portable apparatus for communicating through multiple channels according to claim 11 wherein said display unit displays availability of each of the multiple channels.

14. The wireless portable apparatus for communicating through multiple channels according to claim 9 wherein said input device includes a selection key for selecting the one of the multiple channels.

15. The wireless portable apparatus for communicating through multiple channels according to claim 9 wherein said input device includes pairs of an off-hook key and an on-hook key corresponding to each of the multiple channel respectively for activating and deactivating the multiple channels.
